(19) United States
(12) Patent Application Publication
(10) Pub. No.: US 2016/0119585 A1
(43) Pub. Date: Apr. 28, 2016

(54) METHOD AND APPARATUS FOR FORWARDING A CAMERA FEED

(71) Applicant: MOTOROLA SOLUTIONS, INC, SCHAUMBURG, IL (US)

(72) Inventors: ALEJANDRO G. BLANCO, FORT LAUDERDALE, FL (US); DANIEL A. TEALDI, PLANTATION, FL (US)

(21) Appl. No.: 14/525,694

(22) Filed: Oct. 28, 2014

(51) Int. Cl. H04N 7/18

(52) U.S. Cl. CPC H04N 7/181

(57) ABSTRACT

A device tracks a user's field of vision/view (FOV). Based the FOV, the device may receive video and/or audio from cameras having similar FOVs. More particularly, the device may fetch a camera feed from a camera having a similar FOV as the user. Alternatively, the device may fetch a camera feed from a camera within the user's FOV.

### FIELD OF THE INVENTION

The present invention generally relates to forwarding a camera feed, and more particularly to a method and apparatus for forwarding a camera feed based on a field of view of a user.

### BACKGROUND OF THE INVENTION

Police officers, and other users, oftentimes are in an environment where they wish to see or hear what is going on in different locations. Oftentimes the need to hear or see what is going on in different locations may require a public-safety officer to manually manipulate a device so that an appropriate video feed may be obtained. It would aide an officer if an appropriate video feed can be obtained in an unobtrusive, hands free fashion. For example, a police officer quietly involved in a stakeout, may wish to receive a video feed without having to physically manipulate a device. Therefore, a need exists for a method and apparatus that allows for hands-free selecting of video feeds to be forwarded to the user.

### BRIEF DESCRIPTION OF THE SEVERAL VIEWS OF THE DRAWINGS

The accompanying figures were like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 shows an environment in which concepts described herein may be implemented.

FIG. 2 is an exemplary diagram of a device of FIG. 1.

FIG. 3 is an exemplary block diagram of the device of FIG. 2.

FIG. 4 is an exemplary functional block diagram of the controller of FIG. 1.

FIG. 5 is a flow chart showing operation of the device of FIG. 3.

FIG. 6 is a flow chart showing operation of the controller of FIG. 4.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above, mentioned need, a device may track a user's field of vision/view (FOV). Based the user's FOV, the device may receive video and/or audio from cameras having similar FOVs. More particularly, the device may fetch a camera feed from a camera having a similar FOV as the user's FOV. Alternatively, the device may fetch a camera feed from a camera within the user's FOV.

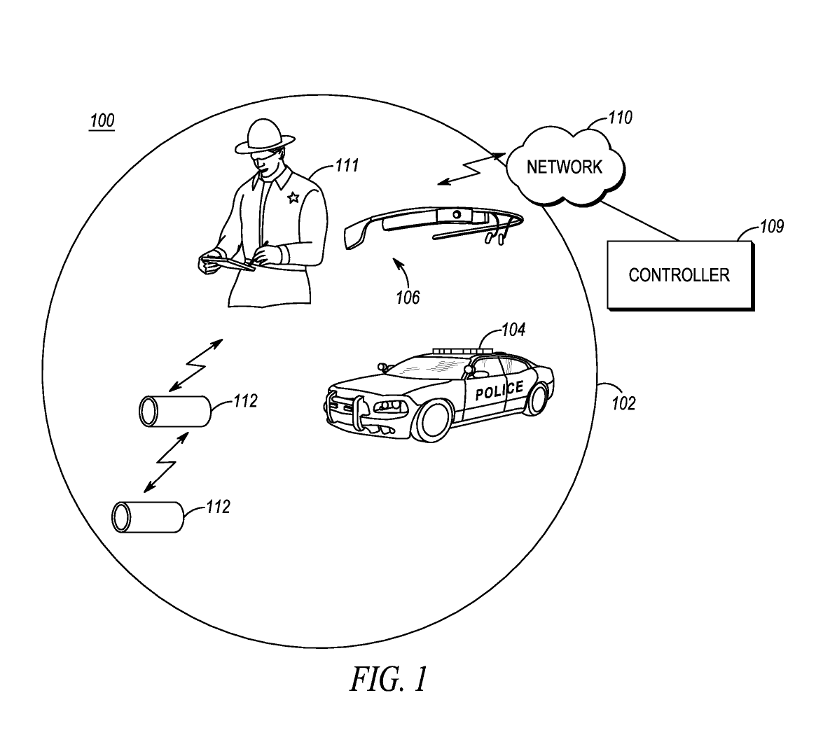

FIG. 1 shows an exemplary environment 100 in which concepts described herein may be implemented. As shown, environment 100 may include an area 102. Within area 102 may be a public-safety officer 111, a vehicle 104, multiple cameras 112, and a device 106. Also included in FIG. 1 is a network 110, and controller 109. In other implementations, environment 100 may include more, fewer, or different components. For example, in one implementation, environment 100 may not include vehicle 104.

Area 102 may encompass a physical region that includes device 106 and one or more cameras 112. Cameras 112 are either directly connected to controller 109, or attached (i.e., connected) to the controller 109 through network 110, and provide a video and/or audio feed to controller 109. Cameras may also be mobile, such as body worn camera on a partner or vehicle based. Cameras 112 capture a sequence of video frames (i.e., a sequence of one or more still images), with optional accompanying audio, in a digital format. Preferably, the images or video captured by cameras 112 is sent directly to controller 109 via a transmitter (not shown in FIG. 1). A particular video feed can be directed to any device upon request.

It should be noted that the term video is meant to encompass both video and audio or simply video only. However, one of ordinary skill in the art will recognize that audio (without accompanying video) may be forwarded as described herein.

Controller 109 is utilized to provide device 106 with an appropriate feed from one of cameras 112. Although controller 109 is shown in FIG. 1 lying outside of area 102, in alternate embodiments of the present invention controller 109 may reside in any piece of equipment shown within area 102. In this scenario, peer-to-peer communications among devices within area 102 may take place without the need for network 110. For example, controller 109 may reside in device 106, cameras 112, or vehicle 104. Controller 109 will determine a field of vision (FOV) for user 111 and provide device 106 a video feed from one of several cameras 112 based on the determined user's FOV. In one embodiment, a video feed from a camera having a FOV that best overlaps or is closest to a user's FOV is forwarded. In another embodiment a video feed from a camera within a user's FOV is forwarded to the user. Controller 109 receives FOV data from device 106 used to determine a user's FOV. The FOV data may comprise the actual FOV as calculated by device 106, or alternatively may comprise information needed to calculate the FOV.

Network 110 may comprise one of any number of over-the-air or wired networks. For example network 110 may comprise a private 802.11 network set up by a building operator, a next-generation cellular communications network operated by a cellular service provider, or any public-safety network such as an APCO 25 network or the FirstNet broadband network.

Device 106 preferably comprises a body-worn camera, display, and speaker such as Google Glass™ or Motorola Solution's HC1 Headset Computer. Preferably, device 106 is worn by user 111 so that device 106 has a FOV that approximately matches the user's FOV. In alternate embodiments, the FOV of the device and the user may not align, but knowing one FOV will allow the calculation of the other FOV. Thus, because device 106 is body worn, device 106 may track its position and thus infer a user's FOV. When the FOV of device 106 is aligned with user 111, device 106 is capable of recording video of a FOV of officer 111. Regardless of whether or not the FOV of user 111 is aligned with the FOV of device 106, device 106 is capable of recording video, displaying the video to the officer 111, and providing the video to controller 109. Device 106 is also capable of receiving and displaying video from any camera 112 (received directly from camera 112 or from controller 109).

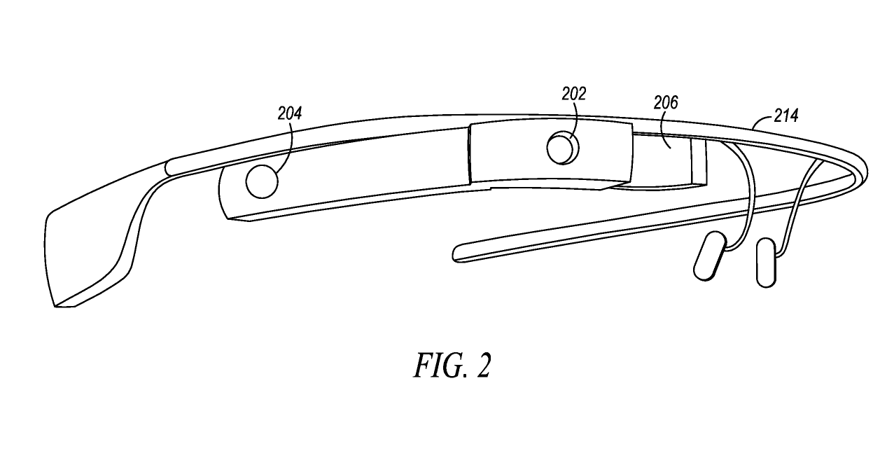

FIG. 2 shows device 106. As illustrated, device 106 may include a camera 202, a speaker 204, a display 206, and a housing 214 adapted to take the shape of a standard eyeglass frame. Camera 202 may enable a user to view, capture, and store media (e.g., images, video clips) of a FOV in front of device 106, which preferably aligns with the user's FOV. Speaker 204 may provide audible information to a user of device 106. Display 206 may include a display screen to provide visual information to the user, such as video images or pictures. In alternate embodiments display 206 may be implemented within in a helmet and not attached to anything resembling an eyeglass frame. In a similar manner speaker 204 may comprise a non-integrated speaker such as ear buds.

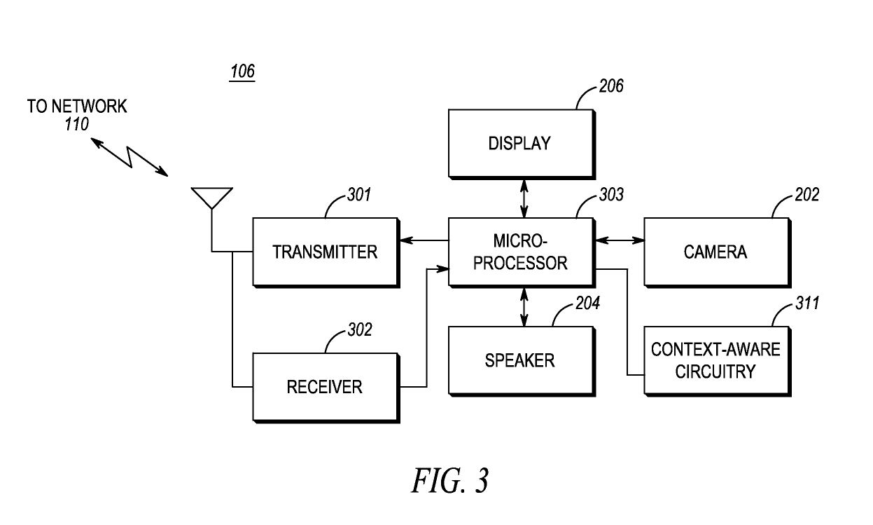

FIG. 3 shows an exemplary block diagram of device 106 of FIG. 2. As shown, device 106 may include transmitter 301, receiver 302, display 206, logic circuitry 303, speaker 204, camera 202, and context-aware circuitry 311. In other implementations, device 106 may include more, fewer, or different components. For example, device 106 may include a zoom lens assembly and/or auto-focus sensors.

Transmitter 301 and receiver 302 may be well known long-range and/or short-range transceivers that utilize a private 802.11 network set up by a building operator, a next-generation cellular communications network operated by a cellular service provider, or any public-safety network such as an APCO 25 network or the FirstNet broadband network. Transmitter 301 and receiver 302 may also contain multiple transmitters and receivers, to support multiple communications protocols simultaneously.

Display 206 may include a device that can display images/video generated by camera 202 as images on a screen (e.g., a liquid crystal display (LCD), organic light-emitting diode (OLED) display, surface-conduction electro-emitter display (SED), plasma display, field emission display (FED), bistable display, projection display, laser projection, holographic display, etc.).

In a similar manner, display 206 may display images/video received over network 110 (e.g., from other cameras 112).

Logic circuitry 101 comprises a digital signal processor (DSP), general purpose microprocessor, a programmable logic device, or application specific integrated circuit (ASIC) and is utilized to accesses context-aware circuitry 311 and determine a camera FOV. From the camera FOV, a user's FOV may be inferred.

Context-aware circuitry 311 may comprise any device capable of generating an estimated FOV for user 111. For example, context-aware circuitry 311 may comprise a combination of a GPS receiver capable of determining a geographic location, a level sensor, and a compass. A camera FOV may comprise a camera's location and/or its pointing direction, for example, a GPS location, a level, and a compass heading. Based on the geographic location, level, and compass heading, a FOV of camera 202 can be determined by microprocessor 303. For example, a current location of camera 202 may be determined (e.g., 42 deg 04′ 03.482343″ lat., 88 deg 03′ 10.443453″ long. 727 feet above sea level), and a compass bearing matching the camera's pointing direction may be determined from the image (e.g., 270 deg. from North), a level direction of the camera may be determined from the image (e.g., −25 deg. from level). From the above information, the camera's FOV is determined by determining a geographic area captured by the camera having objects above a certain dimension resolved. For example a FOV may comprise any two or three-dimensional geometric shape that has, for example, objects greater than 1 cm resolved (occupying more than 1 pixel). In an alternate embodiment of the present invention he FOV may also be determined by the directions as described, but may not involve a resolution component. A user may specify a closer or farther FOV by tilting their head up and down.

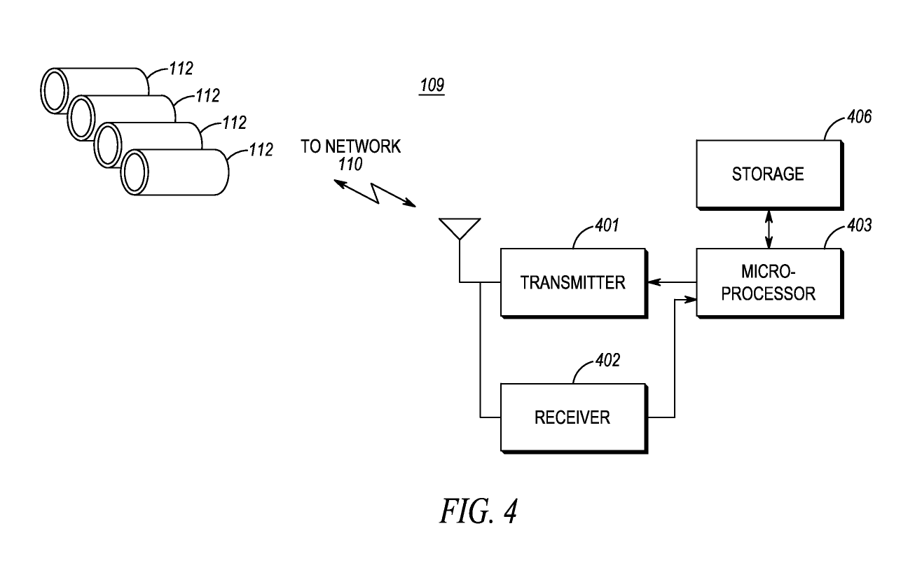

FIG. 4 is a block diagram of the controller of FIG. 1. As shown, controller 109 may include transmitter 401, receiver 402, logic circuitry 403, and storage 406. In other implementations, device 106 may include more, fewer, or different components.

Transmitter 401 and receiver 402 may be well known long-range and/or short-range transceivers that utilize, for example, a private 802.11 network set up by a building operator, a next-generation cellular communications network operated by a cellular service provider, or any public-safety network such as an APCO 25 network or the FirstNet broadband network. Transmitter 401 and receiver 402 may also contain multiple transmitters and receivers, to support multiple communications protocols simultaneously.

Logic circuitry 403 comprises a digital signal processor (DSP), general purpose microprocessor, a programmable logic device, or application specific integrated circuit (ASIC) and is utilized to accesses, determine, or receive a camera FOV, determine other cameras sharing a similar FOV, and provide at least one of the other camera's video feed to device 106.

Storage 406 comprises standard random-access memory and is utilized to store camera feeds from multiple cameras. Storage 406 is also utilized to store a database of camera locations and their associated field of views. More particularly, storage 406 comprises an internal database that has at a minimum, camera identifiers (IDs) along with a location of identified cameras. Along with the locations of cameras 112, a FOV for each camera may also be stored. A camera FOV may comprise a camera's location, level, and/or its pointing direction, for example, a GPS location and a compass and/or level heading. As described above, any camera's FOV may comprise any geometric shape (e.g., a cone) that has, for example, objects greater than 1 cm resolved (occupying more than 1 pixel).

During operation of the system shown in FIG. 1, logic circuitry 303 will determine a users FOV. As discussed above, because camera 202 is body worn, the user's FOV may be inferred from the FOV of the camera 202. Transmitter 301 will then be utilized to transmit the user and/or camera FOV to controller 109. Receiver 402 will receive the user and/or camera FOV and provide the FOV to logic circuitry 403. Logic circuitry 403 will access storage 406 to determine a camera 112 having a similar FOV to that of the user (alternatively, logic circuitry 403 may determine a camera 112 within the FOV of the user). Microprocessor 403 will then direct transmitter 401 to provide a feed of the chosen camera to device 106. More particularly, any video feed received from the chosen camera will be relayed to device 106 for display on display 206. Thus, receiver 302 will receive a video feed from the chosen camera 112, causing microprocessor 303 to forward it to display 206. In the situation where more than one camera feed may satisfy the criteria for forwarding, a best feed may be determined based on, for example, camera resolution (higher resolutions preferred). An option may be provided for the user to be informed of alternate views, and given some non intrusive method for switching to alternate feeds (e.g., shaking their head).

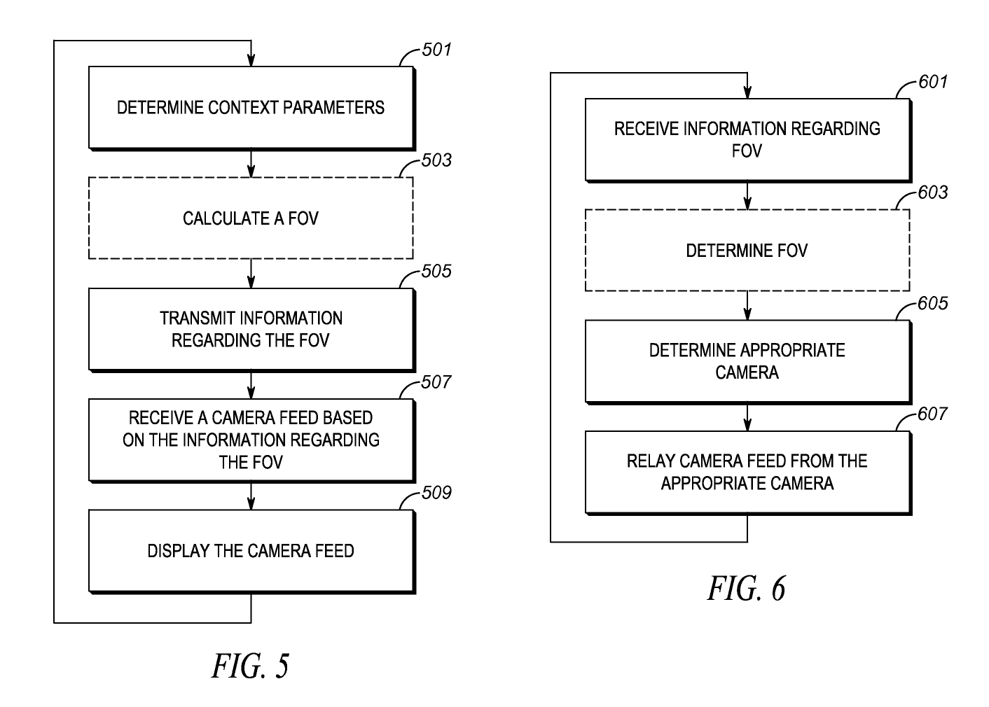

FIG. 5 is a flow chart showing operation of the device of FIG. 3. The logic flow begins at step 501 where logic circuitry 303 determines parameters related to the device's context from context-aware circuitry 311. As discussed above, the parameters may comprise a location, a compass heading, and/or a level. In optional step 503, which is executed in a first embodiment, a FOV is calculated by logic circuitry. As described above, the FOV may simply comprise the FOV of camera 202, or alternatively, may comprise the FOV of user 111. Regardless of whether or not step 503 is executed, at step 505 information regarding the FOV of the user is transmitted (via transmitter 301) to controller 109. The information may comprise any calculated FOV, or alternatively may comprise context parameters determined in step 501. In response to transmitting, at step 507 receiver 302 receives a camera feed that is based on the information transmitted in step 505, and the camera feed is displayed on display 206. As discussed above, the camera feed is preferably relayed from a camera sharing a similar FOV as user 111, however, in an alternate embodiment of the present invention the camera feed may be from a camera within a particular FOV (user's or camera's). It should be noted that the logic flow may return to step 501 so that a change in the camera or user FOV will cause a camera feed to change. For example, a first calculated FOV will cause a feed from a first camera to be relayed from controller 109, while a second calculated FOV will cause a second camera feed to be relayed from controller 109.

The above logic flow results in a method comprising the steps of determining information needed to calculate a first field of view (FOV), transmitting the information needed to calculate the first FOV, and in response to the step of transmitting, receiving a camera feed from a second camera, the camera feed from the second camera having a second FOV, based on the first FOV. In one embodiment of the present invention the first FOV is calculated by device 106.

As discussed, the step of transmitting the information needed to calculate the first FOV comprises the step of transmitting the first FOV, or alternatively transmitting a geographic location, a compass heading, and/or a level. Additionally, the first FOV and the second FOV may overlap, or the second camera is within the first FOV. Finally, the first FOV may comprise a FOV of a body-worn camera and/or a FOV of a user of a device.

FIG. 6 is a flow chart showing operation of the controller of FIG. 1. The logic flow begins at step 601 where receiver 402 receives information regarding a FOV. The information may comprise any calculated FOV (calculated by device 106), or alternatively may comprise context parameters needed to determine a FOV. Optional step 603 is then executed. More particularly, if not received from device 106, a FOV may calculated by logic circuitry 403. As described above, the FOV may simply comprise the FOV of camera 202, or alternatively, may comprise the FOV of user 111. Regardless of whether or not step 603 is executed, logic circuitry determines an appropriate camera feed from a camera 112 at step 605. More particularly, database 406 is accessed to determine a camera sharing a similar view as the received/calculated FOV. Alternatively database 406 may be accessed to determine a camera within the received/calculated FOV. The logic flow then continues to step 607 where the appropriate camera feed is relayed by transmitter 401 to device 106. It should be noted that the logic flow may return to step 601 so that a change in the camera or user FOV will cause a camera feed to change. For example, a first calculated FOV will cause a feed from a first camera to be relayed from controller 109, while a second calculated FOV will cause a second camera feed to be relayed from controller 109.

The above logic flow results in A method comprising the steps of receiving from a device, information needed to calculate a first field of view (FOV) and in response to the step of receiving, transmitting to the device, a camera feed from a second camera, the camera feed from the second camera having a second FOV, based on the first FOV.

As discussed, in one embodiment of the present invention controller 109 may calculate the first FOV or alternatively may simply receive the FOV. The information needed to calculate the first FOV may comprise the actual FOV, or alternatively a geographic location, a compass heading, and/or a level. Finally, the first FOV and the second FOV may overlap or the second camera may be within the first FOV.

In the foregoing specification, specific embodiments have been described. However, one of ordinary skill in the art appreciates that various modifications and changes can be made without departing from the scope of the invention as set forth in the claims below. For example, a hand-operated device may be utilized for the user to point to different locations (FOVs). Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising the steps of:
determining information needed to calculate a first field of view (FOV);
transmitting the information needed to calculate the first FOV; and
in response to the step of transmitting, receiving a camera feed from a second camera, the camera feed from the second camera having a second FOV, based on the first FOV.

2. The method of claim 1 further comprising the step of:
calculating the first FOV.

3. The method of claim 2 wherein the step of transmitting the information needed to calculate the first FOV comprises the step of transmitting the first FOV.

4. The method of claim 1 wherein step of transmitting the information needed to calculate the first FOV comprises transmitting a geographic location, a compass heading, and/or a level.

5. The method of claim 1 wherein the first FOV and the second FOV overlap.

6. The method of claim 1 wherein the second camera is within the first FOV.

7. The method of claim 1 wherein the first FOV comprises a FOV of a body-worn camera and/or a FOV of a user of a device.

8. An apparatus comprising:
logic circuitry determining information needed to calculate a first FOV;
a transmitter transmitting the information needed to calculate the first FOV; and
a receiver, receiving in response to the step of transmitting, a camera feed from a second camera, the camera feed from the second camera having a second FOV, based on the first FOV.

9. The apparatus of claim 8 where the logic circuitry further calculates the first FOV.

10. The apparatus of claim 9 wherein the transmitter transmits the first FOV.

11. The apparatus of claim 8 wherein the information needed to calculate the first FOV comprises a geographic location, a compass heading, and/or a level.

12. The apparatus of claim 8 wherein the first FOV and the second FOV overlap.

13. The apparatus of claim 8 wherein the second camera is within the first FOV.

14. The method of claim 1 wherein the first FOV comprises a FOV of a body-worn camera and/or a FOV of a user of a device.

15. A method comprising the steps of:
determining a geographic location, a compass heading, and/or a level of a body-worn camera;
calculating a first FOV of the body-worn camera based on the geographic location, the compass heading, and/or the level of the body-worn camera;
transmitting information regarding the first FOV; and
in response to the step of transmitting, receiving a camera feed from a second camera, the camera feed from the second camera having a second FOV based on the first FOV.

16. The method of claim 15 wherein the first FOV and the second FOV overlap.

17. The method of claim 15 wherein the second camera is within the first FOV.
